(19) United States
(12) Patent Application Publication
(10) Pub. No.: US 2019/0106934 A1
(43) Pub. Date: Apr. 11, 2019

(54) ROLL UP SWING GATE

(71) Applicant: SUMMER INFANT (USA), INC., Woonsocket, RI (US)

(72) Inventors: Michael Thomas Fusco, Greenville, RI (US); Anthony Carbone, Harrisville, RI (US); Paul M. Brown, Slatersville, RI (US); Luke Timothy Roberts, North Smithfield, RI (US); Arthur Gehr, East Earl, PA (US)

(21) Appl. No.: 16/152,790

(22) Filed: Oct. 5, 2018

Related U.S. Application Data
(60) Provisional application No. 62/568,927, filed on Oct. 6, 2017.

(51) Int. Cl. E06B 9/06; E06B 9/04

(52) U.S. Cl. CPC E06B 9/0692; E06B 2009/002; E06B 9/0638; E06B 9/04

(57) ABSTRACT

A gate assembly including a slat roll, the slat roll configured to be in an open position and a closed position, the slat roll including slats secured to a flexible medium, and a frame, the frame configured to secure and provide structure to the slat roll while in the open position.

### CROSS REFERENCE TO RELATED APPLICATIONS

This application claims benefit from U.S. Provisional Patent Application Ser. No. 62/568,927, filed Oct. 6, 2017, which is incorporated by reference in its entirety.

### BACKGROUND OF THE INVENTION

This invention relates to gates and, more particularly, to a roll up swing gate.

In general, child and pet security gates are commonly used to lock or close passageways such as conventional doorways and entrances to stairwells. There purpose is primarily security, such as keeping small children from having access to stairwells that could present a hazard, and also confinement, such as confining a pet to a particular room during the night.

Many types of child and pet security gates are available on the market today that range from accordion style gates formed from lattice-connected wood slats to lightweight plastic injected molded gates that permit rapid adjustment to width and closure.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features a gate assembly including a slat roll, the slat roll configured to be in an open position and a closed position, the slat roll including slats secured to a flexible medium, and a frame, the frame configured to secure and provide structure to the slat roll while in the open position.

In another aspect, the invention features a method including unrolling a slat roll, sliding top and bottom slat connectors onto to a top and a bottom of the slat gate, sliding upper and lower bar assemblies onto respective top and bottom slat connectors, and snapping respective ends of the upper and lower bar assemblies into end caps located on opposing ends of left and right vertical bars.

In another aspect, the invention features a system including a first gate assembly, a second gate assembly, and a linking mechanism to link the first gate assembly to the second gate assembly and enable the first gate assembly and the second gate assembly to slide in different directions with respect to each other.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 is block diagram of an exemplary roll up swing gate.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

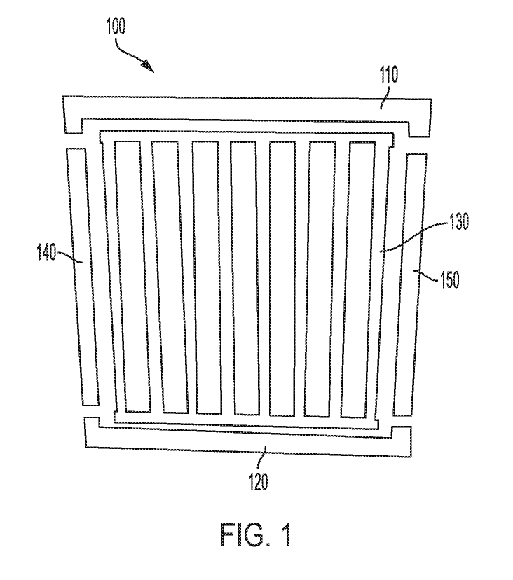

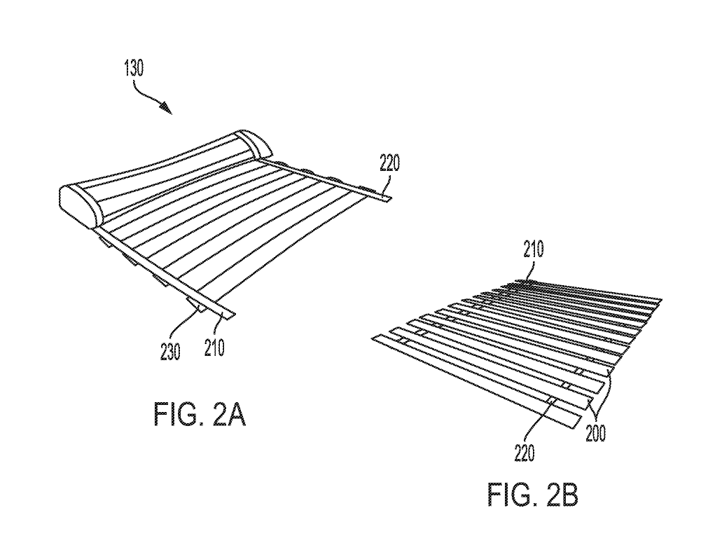

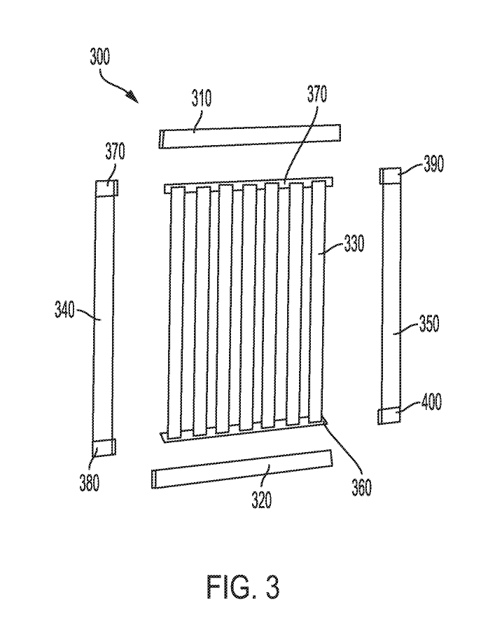

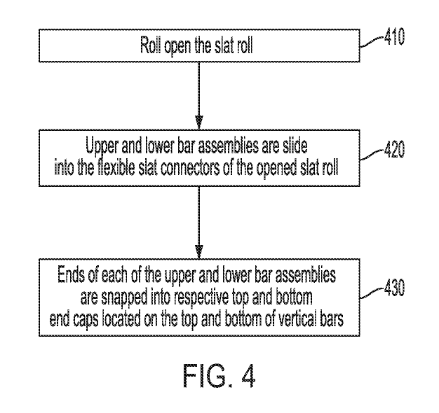

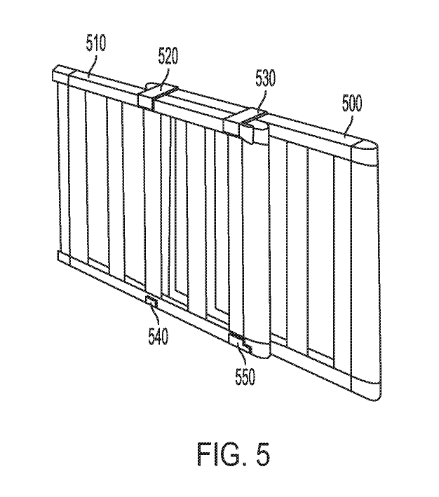

In FIG. 1, an exemplary roll up swing gate 100 includes an upper bar assembly 110, a lower bar assembly 120, a slat roll 130 and two vertical bars 140, 150. The two vertical bars 140, 150 are configured to removably link to opposite ends of he lower bar assembly 120. Each of the two vertical bars 140, 150 includes a channel to receive and removably secure to opposite ends of the slat roll 130. Once the slat roll 130 is positioned within the channels of the vertical bars 140, 150, the upper bar assembly 110 is removably linked to a top portion of the slat roll 130.

The slat roll 130 is designed to be rolled up when not in use and rolled out while in use. In FIG. 2A, the slat roll 130 is shown in a rolled out configuration and includes a number of wooden slats 200 secured to two lengths of flexible medium 210, 220. In the embodiment illustrated, the wooden slats 200 are secured to the lengths of flexible medium 210, 220 using fasteners.

In FIG. 2B, the slat roll 130 is shown in a partially rolled up configuration. In the embodiment illustrated, the wooden slats 200 are secured to the lengths of flexible medium 210, 220 by molded plastic caps 230 to enable the slat roll 130 to be rolled up as tight as possible for easy transportation and storage.

In FIG. 3, an exemplary roll up swing gate 300 is illustrated in greater detail and includes an upper bar assembly 310, a lower bar assembly 320, a slat roll 330 and two vertical bars 340, 350. The two vertical bars 340, 350 are configured to removably link to opposite ends of the lower bar assembly 320. Each of the two vertical bars 340, 350 includes a channel to receive and removably secure to opposite ends of the slat roll 330.

In a preferred embodiment, the slat roll 330 is a wooden panel having upper and lower flexible slat connectors 360, 370 that secure individual wooden slats. In other embodiments, the slat roll is constructed of other materials, such as plastic slats secured to a flexible medium.

The two vertical bars 340, 350 are preferably constructed of extruded aluminum, as are the upper bar and lower bar assemblies 310, 320.

Each of the vertical bars 340, 350 includes a pair of upper and lower end caps positioned at its opposite ends. More specifically, vertical bar 340 includes end caps 370, 380 and vertical bar 350 includes end caps 390, 400. Each of the end caps 370, 380, 390, 400 are modular and snap universally onto the ends of their respective vertical bars 340, 350. During assembly, respective ends of the upper and lower bar assemblies 310, 320, securing the slat roll 330 in a frame created by the upper bar and lower bar assemblies 310, 320 and two vertical bars 340, 350.

As shown in FIG. 4, assembly of the roll up swing gate 300 rolling open (410) the slat roll. Upper and lower bar assemblies are slide (420) into the flexible slat connectors of the opened slat roll. Ends of each of the upper and lower bar assemblies are snapped (430) into respective top and bottom end caps located on the top and bottom of vertical bars.

Disassembly of the roll up swing gate 300 is the reverse.

As shown in FIG. 5, in one embodiment, a first roll up swing gate 500 may be secured to a second roll up swing gate 510 with multiple braces 520, 530, 540, 550 to enable the first and second swing gates 500, 510 to slide horizontally with respect to each other.

As shown in FIG. 6, in another embodiment, multiple swing gates may be secured to each other in such a fashion as to provide a playpen type structure for an infant.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A gate assembly comprising:
a slat roll, the slat roll configured to be in an open position and a closed position, the slat roll comprising slats secured to a flexible medium; and
a frame, the frame configured to secure and provide structure to the slat roll while in the open position.

2. The gate assembly of claim 1 wherein the slat roll includes upper and lower flexible slat connectors.

3. The gate assembly of claim 1 wherein the slat roll comprises a plurality of wooden slats.

4. The gate assembly of claim 1 wherein the slat roll in the open position further comprises top and bottom slat connectors.

5. The gate assembly of claim 3 wherein the plurality of wooden slats connected to flexible medium by molded plastic caps.

6. The gate assembly of claim 3 wherein the plurality of wooden slats are fastened to the flexible medium.

7. The gate assembly of claim 2 wherein the frame comprises:
an upper bar assembly having an upper bar assembly channel to receive the upper flexible connector; and
a lower bar assembly having a lower bar assembly channel to receive the lower flexible connector.

8. The gate assembly of claim 7 wherein the frame further comprises:
a first vertical bar, the first vertical bar having upper and lower end caps positioned on opposite ends and configured to receive and removably attach proximate ends of the upper and lower bar assemblies; and
a second vertical bar, the second vertical bar having upper and lower end caps positioned on opposite ends and configured to receive and removably attach distal ends of the upper and lower bar assemblies.

9. A method comprising:
unrolling a slat roll;
sliding top and bottom slat connectors onto to a top and a bottom of the slat gate;
sliding upper and lower bar assemblies onto respective top and bottom slat connectors; and
snapping respective ends of the upper and lower bar assemblies into end caps located on opposing ends of left and right vertical bars.

10. The method of claim 9 wherein the slat roll comprises a plurality of wooden slats.

11. The method of claim 10 wherein the plurality of wooden slats connected to flexible medium by molded plastic caps.

12. The method of claim 10 wherein the plurality of wooden slats are fastened to flexible medium.

13. The method of claim 9 wherein the upper bar assembly includes an upper bar assembly channel to receive the top slat connector; and
a lower bar assembly includes a lower bar assembly channel to receive the bottom slat connector.

14. A system comprising:
a first gate assembly;
a second gate assembly; and
a linking mechanism to link the first gate assembly to the second gate assembly and enable the first gate assembly and the second gate assembly to slide in different directions with respect to each other.

15. The system of claim 14 wherein each of the first and second gate assemblies comprises:
a slat roll, the slat roll configured to be in an open position and a closed position, the slat roll comprising slats secured to a flexible medium; and
a frame, the frame configured to secure and provide structure to the slat roll while in the open position.

16. The system of claim 15 wherein the slat roll comprises a plurality of wooden slats.

17. The system of claim 15 wherein the slat roll in the open position further comprises top and bottom slat connectors.

18. The system of claim 16 wherein the plurality of wooden slats are connected to flexible medium by molded plastic caps or fastened to the flexible medium.

19. The gate assembly of claim 2 wherein the frame comprises:
an upper bar assembly having an upper bar assembly channel to receive the upper flexible connector; and
a lower bar assembly having a lower bar assembly channel to receive the lower flexible connector.

20. The system of claim 15 wherein the frame further comprises:
a first vertical bar, the first vertical bar having upper and lower end caps positioned on opposite ends and configured to receive and removably attach proximate ends of the upper and lower bar assemblies; and
a second vertical bar, the second vertical bar having upper and lower end caps positioned on opposite ends and configured to receive and removably attach distal ends of the upper and lower bar assemblies.
